(19) United States
(12) Patent Application Publication
(10) Pub. No.: US 2001/0039191 A1
(43) Pub. Date: Nov. 8, 2001

(54) Method for transmitting a text message

(76) Inventor: Dietmar Maierhofer, Munchen (DE)

Correspondence Address: Lerner and Greenberg, P.A., P.O. Box 2480, Hollywood, FL, 33022-2480, US

(21) Appl. No.: 09/730,269

(22) Filed: Dec. 5, 2000

(30) Foreign Application Priority Data
Dec. 6, 1999 (DE) 199 58 707.8

(51) Int. Cl. H04Q 7/20

(52) U.S. Cl. 455/466; 455/408; 455/414

(57) ABSTRACT

A method for transmitting a text message from a first mobile radio terminal to a second mobile radio terminal in a mobile radio network linked to a data network, in particular to an IP network. The entered data being routed together with the telephone number and a data network address for the first mobile radio terminal to an associated service control point in the mobile radio/data network in order to check the memory content and also to perform a debit operation and to forward the text message.

### BACKGROUND OF THE INVENTION

Field of the Invention

The invention relates to a method for transmitting a text message between a first mobile radio terminal and a second mobile radio terminal in a mobile radio network.

Whereas, in the initial years of mobile radio technology, voice transmission was of almost exclusive significance, the transmission of text is quickly becoming more and more significant today. Within the actual established mobile radio networks, the transmission of short messages using a short message service (SMS) is for many customers an important service which, despite the relatively inconvenient operation, is in popular use, particularly on account of the charges. In connection with the introduction of the mobile radio-related Internet protocol wireless application protocol (WAP), suddenly extended capabilities and useful effects are becoming available for the transmission of text. The Internet access which is possible using WAP turns the appropriately configured mobile radio terminal into an important information instrument, the additional set of functions being provided by text transmissions.

A further important trend in mobile radio technology is the increased use of credits paid for in advance, so-called prepaid credits or accounts. With these tariffs, no basic charge is calculated, but instead only the calls actually made are paid for. However, users of prepaid credits do not have access to all the service features of the mobile radio networks. In particular, according to the current situation, the users of prepaid credits are not able to send any short messages using the SMS because they cannot be charged for by the network operator. This also concerns owners of mobile radio terminals with WAP capability. They are also subject to restrictions regarding the provision of information which can be retrieved from the Internet, assuming that the terminal is to be operated using a prepaid credit.

### SUMMARY OF THE INVENTION

It is accordingly an object of the invention to provide a method for transmitting a text message which overcomes the above-mentioned disadvantages of the prior art methods of this general type, which method permits the transmission of text even when the mobile radio network is used in a prepaid mode.

With the foregoing and other objects in view there is provided, in accordance with the invention, a method for transmitting text messages. The method includes providing a first mobile radio terminal and a second mobile radio terminal in a mobile radio network linked to a data network, the first mobile radio terminal is configured for communicating with the data network and is operated in a prepaid mode. A transmission mask is loaded in the first mobile radio terminal. Data, including a text message and a telephone number of the second mobile radio terminal, is entered into the transmission mask. The transmission mask containing the data is transmitted to an application server in the data network linked to the mobile radio network. The data together with one of the telephone number and a data network address for the first mobile radio terminal is forwarded to an associated service control point in the mobile radio network linked to the data network. The service control point has a prepaid account memory associated with the first mobile radio terminal. A memory content of the prepaid account memory is checked and the prepaid account memory is debited. The text message and the telephone number of the second mobile radio terminal are forwarded to a text transmission service center in the mobile radio network linked to the data network or a termination indicator signal is output to the first mobile radio terminal on a basis of a result of the checking step. The text message is transmitted from the text transmission service center to the second mobile radio terminal if the result of the checking step is positive.

The invention embraces the fundamental concept of performing a credit check and—if there is sufficient credit—debiting a prepaid credit for the mobile radio subscriber at the appropriate service control point before the text message is transmitted. The text transmission is carried out only if sufficient credit has been verified.

In accordance with its first aspect, the invention also embraces the fundamental concept of entering a text message which is to be transmitted and the telephone number of the addressee into the transmission mask which is configured for transmission to the application server in the mobile radio network, linked to the data network, and for the handling in the mobile radio network. The IP address of the originator included with the transmission mask during the attempt to transmit the text message permits the transmission mask to be supplied to that service control point at which the prepaid account of the originator is managed. Once the credit has been checked there and, in the positive case, a debit operation has been performed, the text message is delivered to the addressee via a text transmission service center in the network.

In accordance with the second embodiment, the invention also embraces the concept of routing a text message transmitted by an information provider via the application server (specifically referred to as “wireless telephony application” (WTA) server”) and also—in this case—via the service control point at which the prepaid account of the addressee is managed. A check is then carried out there to determine whether the addressee has sufficient credit, and, if the result of the check is positive, an appropriate debit operation is performed. The text message can then be delivered to the addressee via a text transmission service center (specifically a short message service center (SMSC) in the case of a SMS).

In both fundamental embodiments, the capabilities of the WAP are advantageously used.

In a further advantageous embodiment, in addition to the actual text and the telephone number of the addressee, the type of text transmission can be specified at the same time during entry, and a SMS, an E-mail or a fax format, for example, is then chosen on the basis of the entry and the message is routed via an appropriate gateway in the mobile radio system.

The aforementioned transmission mask is, in particular, in the form of a so-called wireless markup language start page which can either be requested from the application server by the originator using his mobile radio terminal and is then delivered to him using a push mechanism, or may be stored in the terminal.

In one advantageous embodiment, a sufficiently meaningful return message is produced for and delivered to the originator, for example the return message that the second subscriber address does not exist or the message that the text message could not be delivered on account of insufficient credit, or the notification of when the message has been transmitted.

A further advantageous embodiment provides for distribution lists to be set up and administered on the application server, in which case the originator need now specify only a predetermined distribution list once setup is complete, and the application server/service control point or the text transmission service center then distributes the messages.

In expedient embodiments based on the second aspect of the invention, it is possible to subscribe to information services conveniently, the interested party being able to make settings for text messages in general and/or with an originator reference within the context of his prepaid credit cost limit. It is also possible to specify originators from whom no information (which is to be paid for) is desired. These options are provided by a telephone number-related or an IP address-related administration of partial amounts of the prepaid credit.

The proposed solution advantageously also permits international roaming when transmitting text messages on a prepaid basis.

In accordance with an added feature of the invention, there is the step of reading in a wireless markup language (WML) start page from a memory in the first mobile radio terminal during the loading step and using the WML start page as the transmission mask.

In accordance with an additional feature of the invention, there is the step of transmitting a wireless markup language (WML) start page from the text transmission service center to the first mobile radio terminal upon an interrogation step which precedes the loading step, and using the WML start page as the transmission mask.

In accordance with another feature of the invention, there is the step of generating a message being a transmission confirmation message or a transmission error message and transmitting the message to the first mobile radio terminal. The message is generated due to a trigger signal produced by the text transmission service center in the mobile radio network linked to the data network and the message is transmitted via the service control point associated with the first mobile radio terminal.

In accordance with an added feature of the invention, there is the step of using an Internet protocol network as the data network.

With the foregoing and other objects in view there is further provided, in accordance with the invention, a method for transmitting text messages. The method includes providing a first mobile radio terminal and a predetermined plurality of second mobile radio terminals in a mobile radio network linked to a data network. The first mobile radio terminal is configured for communicating with the data network and is operated in a prepaid mode. At least one telephone number group for the predetermined plurality of second mobile radio terminals is stored in a telephone number memory in a text transmission service center in association with a distribution code. A transmission mask is loaded in the first mobile radio terminal. Data, including a text message and the distribution code of the second mobile radio terminals, is entered into the transmission mask. The transmission mask containing the data is transmitted to an application server in the data network linked to the mobile radio network. The data together with the distribution code or a data network address for the first mobile radio terminal is forwarded to an associated service control point in the mobile radio network linked to the data network. The service control point has a prepaid account memory associated with the first mobile radio terminal. A memory content of the prepaid account memory is checked and the prepaid account memory is debited. The text message and the distribution code of the second mobile radio terminals are forwarded to the text transmission service center in the mobile radio network linked to the data network or a termination indicator signal is output to the first mobile radio terminal on a basis of a result of the checking step. The text message is transmitted from the text transmission service center to the second mobile radio terminals if the result of the checking step is positive.

With the foregoing and other objects in view there is additionally provided, in accordance with the invention, a method for transmitting text messages. The method includes providing a transmission device of an information provider configured for communicating with a data network. The transmission device communicates with a mobile radio terminal operated in a prepaid mode in a mobile radio network linked to the data network. A text message and a telephone number or a data network address of the mobile radio terminal is entered into the transmission device. The text message and one of the telephone number and the data network address is transmitted to an application server in the mobile radio network linked to the data network. The text message together with the telephone number or the data network address of the mobile radio terminal is forwarded to an associated service control point in the mobile radio network linked to the data network. The service control point is connected to a prepaid account memory for the mobile radio terminal. A memory content of the prepaid account memory is checked and the prepaid account memory is debited accordingly. The text message and the telephone number is forwarded to a text transmission service center in the mobile radio network linked to the data network or a termination indicator signal is output to the transmission device on a basis of a result of the checking step. The text message is transmitted from the mobile radio network to the mobile radio terminal if the result of the checking step is positive.

In accordance with an added feature of the invention, there is the step of transmitting the text message under a wireless application protocol.

In accordance with an added feature of the invention, there is the step of entering a text transmission mode, and routing the text message in a short message service format, an E-mail format or a facsimile format through a short message gateway, an E-mail gateway or a facsimile gateway.

In accordance with an additional feature of the invention, there is the step of transmitting a global limit control signal to the service control point using the mobile radio terminal. The global limit control signal releases a partial amount of a prepaid credit for debit purposes for all kinds of text messages.

In accordance with a further feature of the invention, there is the step of transmitting at least one special limit control signal to the service control point using the mobile radio terminal. The special limit control signal releases a respective partial amount of a prepaid credit in relation to a respective predetermined telephone number or a data network address for an originator for debit purposes for the text messages from the originator.

In accordance with a concomitant feature of the invention, there is the step of transmitting at least one block control signal to the service control point using the mobile radio terminal, the block control signal preventing any debit from a prepaid credit for the text messages from at least one predetermined originator.

Other features which are considered as characteristic for the invention are set forth in the appended claims.

Although the invention is illustrated and described herein as embodied in a method for transmitting a text message, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram explaining a first embodiment according to the invention; and

FIG. 2 is a block diagram explaining a second embodiment of the invention.

### DESCRIPTION OF THE PREFERRED EMBODIMENTS

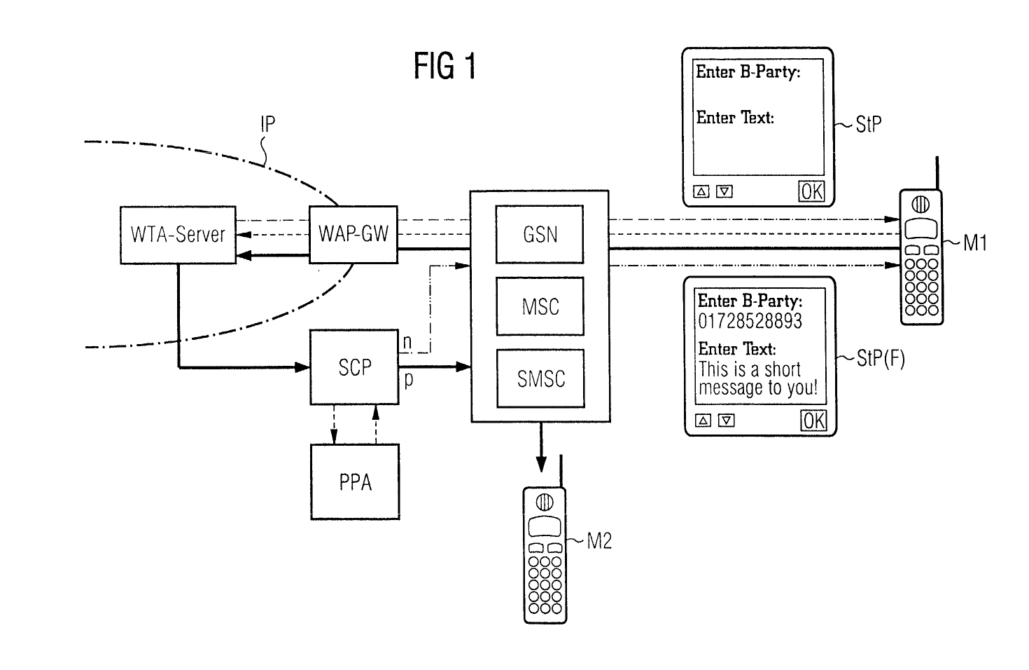

In all the figures of the drawing, sub-features and integral parts that correspond to one another bear the same reference symbol in each case. Referring now to the figures of the drawing in detail and first, particularly, to FIG. 1 thereof, there is shown a basic illustration of a sequence for a transmission of a short message using a short message service (SMS) from a first mobile radio terminal M1, which is operated on a basis of a prepaid credit (PPC), to a second mobile radio terminal M2 in a simple embodiment.

The owner of the first mobile radio terminal M1 wants to send a SMS to the owner of the second mobile radio terminal M2, the SMS is intended to be charged to his prepaid credit. He uses a request signal (shown in dashes forming a dashed line in FIG. 1) to request a transmission mask in the form of a wireless markup language (WML) start page StP from an application server WTA-Server in an IP network IP linked to a mobile radio network, and the start page StP is delivered to the first mobile radio terminal M1 using a push mechanism. The owner of the first mobile radio terminal M1 enters the telephone number of the addressee and the text of the short message and sends off the completed start page StP(F).

The completed start page StP(F) is transmitted (indicated in FIG. 1 by a solid bold arrow) via a wireless application protocol gateway WAP-GW to the application server WTA-Server and is forwarded from there, on the basis of the IP address of the first mobile radio terminal M1 (which is automatically transmitted at the same time when the message is sent), to a service control point SCP in the mobile radio network at which a prepaid account memory PPA associated with the first mobile radio terminal M1 is established.

At the service control point SCP, a credit checking and debit procedure (indicated in FIG. 1 by two arrows made up of short dashes) is initiated and carried out. If the result of the check is negative, i.e. if there is insufficient credit available (identified in FIG. 1 by the letter “n”), the short message is not delivered, but rather a termination signal—identified in FIG. 1 by a double dash-dotted line—is transmitted back to the first mobile radio terminal M1. If the result of the check is positive (indicated in FIG. 1 by the letter “p”), the short message is transmitted to a text transmission service center SMSC and is delivered by the latter to the second mobile radio terminal M2.

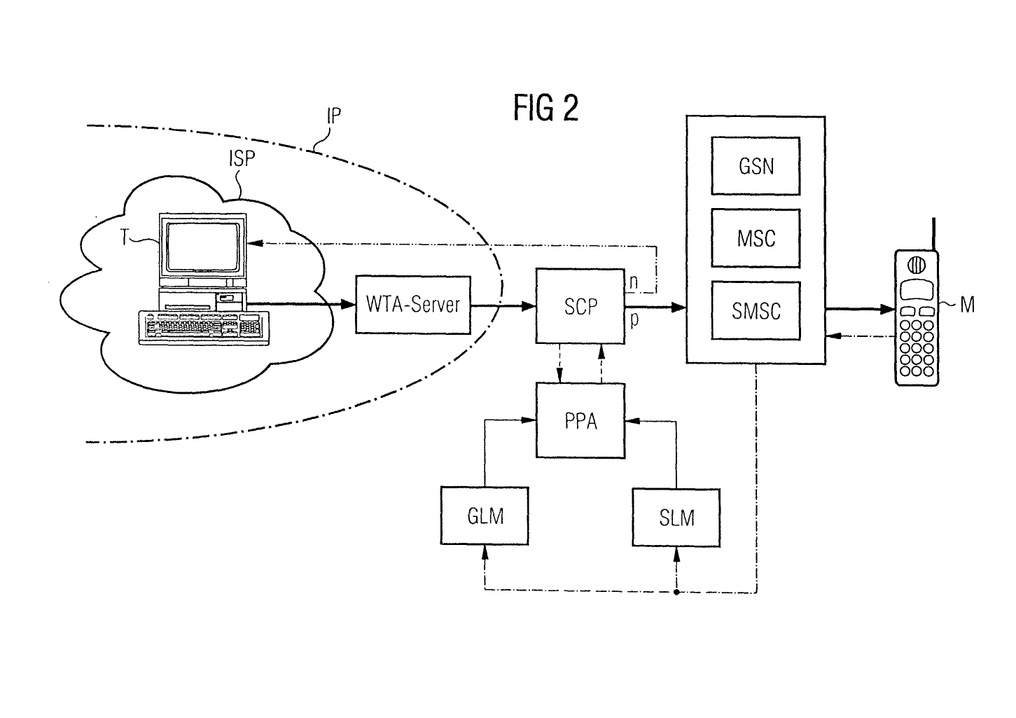

FIG. 2 is a sketch of a modified configuration for delivering so-called terminating short messages within the context of an Internet-based information service.

An information provider ISP in the IP network IP transmits information that is to be paid for from a transmission device T (i.e. a personal computer) to subscribers of an information service. One of the subscribers uses a mobile radio terminal M with a WAP capability to receive the information, the mobile radio terminal M being operated on the basis of a prepaid credit which is handled in the prepaid account memory PPA at the service control point SCP.

From the transmission device T, a text message is first sent to the application server WTA-Server in the IP network IP, and from there it is sent, on the basis of the IP address (entered by the originator) of the mobile radio terminal M, to the service control point SCP, which has the prepaid account memory PPA of the addressee allocated to it. In the embodiment shown, the prepaid account memory PPA has an associated global limit memory GLM and an associated special limit memory SLM, which can both be programmed from the mobile radio terminal M. The latter stores a prepaid credit (global limit) portion that is available in total for the purpose of charging for text messages, or stores maximum amounts (special limits) reserved for text messages from predetermined originators. The limits can be changed or deleted at any time using the mobile radio terminal M.

At the service control point SCP, appropriate comparator devices are used to check whether the total credit is sufficient for delivery of the message to the mobile radio terminal M and whether the global limit for text messages and the special limit set for the provider ISP have not yet been exceeded. If the result of the check is positive overall (also denoted by the reference symbol “p” in FIG. 2), the text message is delivered to the mobile radio terminal M via the text transmission service center SMSC. If one of the comparison procedures has a negative result (also denoted in FIG. 2 by the reference symbol “n”), a termination indicator signal is transmitted to the transmission device T of the provider ISP as a return message.

The embodiment of the invention is not restricted to the examples described above, but is likewise possible in a multiplicity of modifications within the scope of expert action.

I claim:

1. A method for transmitting text messages, which comprises the steps of:
providing a first mobile radio terminal and a second mobile radio terminal in a mobile radio network linked to a data network, the first mobile radio terminal configured for communicating with the data network and operated in a prepaid mode;
loading a transmission mask in the first mobile radio terminal;
entering data, including a text message and a telephone number of the second mobile radio terminal, into the transmission mask;
transmitting the transmission mask containing the data to an application server in the data network linked to the mobile radio network;
forwarding the data together with one of the telephone number and a data network address for the first mobile radio terminal to an associated service control point in the mobile radio network linked to the data network, the service control point having a prepaid account memory associated with the first mobile radio terminal;
checking a memory content of the prepaid account memory and debiting the prepaid account memory;
forwarding the text message and the telephone number of the second mobile radio terminal to a text transmission service center in the mobile radio network linked to the data network or outputting a termination indicator signal to the first mobile radio terminal on a basis of a result of the checking step; and
transmitting the text message from the text transmission service center to the second mobile radio terminal if the result of the checking step is positive.

2. The method according to claim 1, which comprises reading in a wireless markup language (WML) start page from a memory in the first mobile radio terminal during the loading step and using the WML start page as the transmission mask.

3. The method according to claim 1, which comprises transmitting a wireless markup language (WML) start page from the text transmission service center to the first mobile radio terminal upon an interrogation step which precedes the loading step, and using the WML start page as the transmission mask.

4. The method according to claim 1, which comprises generating a message being one of a transmission confirmation message and a transmission error message and transmitting the message to the first mobile radio terminal.

5. The method according to claim 4, which comprises generating the message due to a trigger signal produced by the text transmission service center in the mobile radio network linked to the data network and transmitting the message via the service control point associated with the first mobile radio terminal.

6. The method according to claim 1, which comprises using an Internet protocol network as the data network.

7. A method for transmitting text messages, which comprises the steps of:
providing a first mobile radio terminal and a predetermined plurality of second mobile radio terminals in a mobile radio network linked to a data network, the first mobile radio terminal configured for communicating with the data network and operated in a prepaid mode;
storing at least one telephone number group for the predetermined plurality of second mobile radio terminals in a telephone number memory in a text transmission service center in association with a distribution code;
loading a transmission mask in the first mobile radio terminal;
entering data, including a text message and the distribution code of the second mobile radio terminals, into the transmission mask;
transmitting the transmission mask containing the data to an application server in the data network linked to the mobile radio network;
forwarding the data together with one of the distribution code and a data network address for the first mobile radio terminal to an associated service control point in the mobile radio network linked to the data network, the service control point having a prepaid account memory associated with the first mobile radio terminal;
checking a memory content of the prepaid account memory and debiting the prepaid account memory;
forwarding the text message and the distribution code of the second mobile radio terminals to the text transmission service center in the mobile radio network linked to the data network or outputting a termination indicator signal to the first mobile radio terminal on a basis of a result of the checking step; and
transmitting the text message from the text transmission service center to the second mobile radio terminals if the result of the checking step is positive.

8. A method for transmitting text messages, which comprises the steps of:
providing a transmission device of an information provider configured for communicating with a data network, the transmission device communicating with a mobile radio terminal operated in a prepaid mode in a mobile radio network linked to the data network;
entering a text message and one of a telephone number and a data network address of the mobile radio terminal in the transmission device;
transmitting the text message and one of the telephone number and the data network address to an application server in the mobile radio network linked to the data network;
forwarding the text message together with one of the telephone number and the data network address of the mobile radio terminal to an associated service control point in the mobile radio network linked to the data network, the service control point is connected to a prepaid account memory for the mobile radio terminal;
checking a memory content of the prepaid account memory and debiting the prepaid account memory accordingly;
forwarding the text message and the telephone number to a text transmission service center in the mobile radio network linked to the data network or outputting a termination indicator signal to the transmission device on a basis of a result of the checking step; and
transmitting the text message from the mobile radio network to the mobile radio terminal if the result of the checking step is positive.

9. The method according to claim 8, which comprises transmitting the text message under a wireless application protocol.

10. The method according to claim 8, which comprises entering a text transmission mode, and routing the text message in one of a short message service format, an E-mail format and a facsimile format through one of a short message gateway, an E-mail gateway and a facsimile gateway.

11. The method according to claim 8, which comprises generating a message being one of a transmission confirmation message and a transmission error message, and transmitting the message to the transmission device.

12. The method according to claim 11, which comprises generating the message in response to a trigger signal from the text transmission service center in the mobile radio network linked to the data network, and transmitting the message from the service control point to the mobile radio terminal.

13. The method according to claim 8, which comprises transmitting a global limit control signal to the service control point using the mobile radio terminal, the global limit control signal releasing a partial amount of a prepaid credit for debit purposes for all kinds of text messages.

14. The method according to claim 8, which comprises transmitting at least one special limit control signal to the service control point using the mobile radio terminal, the special limit control signal releasing a respective partial amount of a prepaid credit in relation to a respective predetermined telephone number or a data network address for an originator for debit purposes for the text messages from the originator.

15. The method according to claim 8, which comprises transmitting at least one block control signal to the service control point using the mobile radio terminal, the block control signal preventing any debit from a prepaid credit for the text messages from at least one predetermined originator.

16. The method according to claim 8, which comprises using an Internet protocol network as the data network.
